(19) United States
(12) Patent Application Publication
(10) Pub. No.: US 2007/0033371 A1
(43) Pub. Date: Feb. 8, 2007

(54) Method and apparatus for establishing a cache footprint for shared processor logical partitions

(76) Inventors: Andrew Dunshea, Austin, TX (US); Greg R. Mewhinney, Austin, TX (US); Mysore Sathyanarayana Srinivas, Austin, TX (US)

Correspondence Address: IBM CORP (YA);C/O YEE & ASSOCIATES PC, P.O. BOX 802333, DALLAS, TX, 75380, US

(21) Appl. No.: 11/197,616

(22) Filed: Aug. 4, 2005

(51) Int. Cl. G06F 12/00

(52) U.S. Cl. 711/173; 711/118

(57) ABSTRACT

A computer implemented method, apparatus, and computer usable code for managing cache information in a logical partitioned data processing system. A determination is made as to whether a unique identifier in a tag associated with a cache entry in a cache matches a previous unique identifier for a currently executing partition in the logical partitioned data processing system when the cache entry is selected for removal from the cache, and saves the tag in a storage device if the partition identifier in the tag matches the previous unique identifier.

### BACKGROUND OF THE INVENTION

1. Field of the Invention

The present invention relates generally to an improved data processing system and in particular to a method and apparatus for processing data. Still more particularly, the present invention relates to a method, apparatus, and computer usable code for managing data in a cache.

2. Description of the Related Art

Virtualization through shared processor logical partitions (SPLPAR) is a technology that allows multiple operating system instances to share a single processor. Prior to shared processor logical partitions, an individual processor was the domain of a single operating system. Shared processor logical partitions are enabled by a special management layer known as the Hypervisor, which is a product of International Business Corporation. To run multiple operating system instances on a single processor, the Hypervisor periodically stops one partition, saves its state, and starts another on the same processor. For shared processor logical partitions to offer performance that is competitive with single system image machines, the overhead of this partition switch must be minimized. One type of overhead involves the re-establishment of an L2 cache footprint for an incoming partition that shares a processor with one or more other partitions. An L2 cache footprint is a subset of a processes' data which normally resides in L2 cache when the process is running on a processor.

A cache is a component in a data processing system used to speed up data transfer. A cache may be temporary or permanent. With respect to caches used by processors, these types of caches are typically used to allow instructions to be executed and data to be read and written at a higher speed as opposed to using main memory. Instructions and data are transferred from main memory to cache in blocks. This transfer is typically performed using a look-ahead algorithm.

When instructions in the routine are sequential or the data being read or written is sequential, a greater chance is present that the next required item will already be presented in the cache. This situation results in better performance in the data processing system.

Examples of caches include memory caches, hardware and software disk caches, and page caches. With respect to caches used by microprocessors for executing code, many systems are built in which a level one cache is provided in which the level one cache is accessed at the speed of the processor. This level one cache also is referred to as a L1 cache. Additionally, most systems also include a level two cache, also referred to as a L2 cache. This L2 cache is often integrated with the processor. For example, a processor that is placed on a motherboard often really contains two chips. One chip contains the processor circuit with an L1 cache. The other chip contains an L2 cache. These types of systems also include a level three or L3 cache. This L3 cache is often designed as a special memory bank that is located on the motherboard, providing faster access than main memory, but slower access than an L2 or L3 cache on the processor itself. Entries in the L2 cache are the most current and most entries in the L2 cache need to be reloaded when switching virtual partitions in a data processing system.

Currently, upon a partition switch, the incoming partition re-establishes its L2 cache footprint in the same way that a non shared processor logical partitions system would on startup. Data is brought into the cache as it is accessed from main memory. This method is a slow process that exacts a heavy toll on performance when a partition switch occurs.

### SUMMARY OF THE INVENTION

The present invention provides a computer implemented method, apparatus, and computer usable code for managing cache information in a logical partitioned data processing system. A determination is made as to whether a unique identifier in a tag associated with a cache entry in a cache matches the previous unique identifier for the previously executing partition in the logical partitioned data processing system when the cache entry is selected for removal from the cache. The tag is saved in a storage device if the unique identifier in the tag matches the previous partition identifier.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a data processing system in which aspects of the present invention may be implemented;

FIG. 2 is a block diagram of an exemplary logical partitioned platform in which the present invention may be implemented;

FIG. 3 is a diagram illustrating components used in managing cache entries in a multi-level cache system in accordance with an illustrative embodiment of the present invention;

FIG. 4 is a flowchart of a process for marking cache entries in accordance with an illustrative embodiment of the present invention;

FIG. 5 is a flowchart of a process for removing cache entries from a cache in accordance with an illustrative embodiment of the present invention; and

FIG. 6 is a flowchart of a process for prefetching data in accordance with an illustrative embodiment of the present invention.

### DETAILED DESCRIPTION OF THE PREFERRED EMBODIMENT

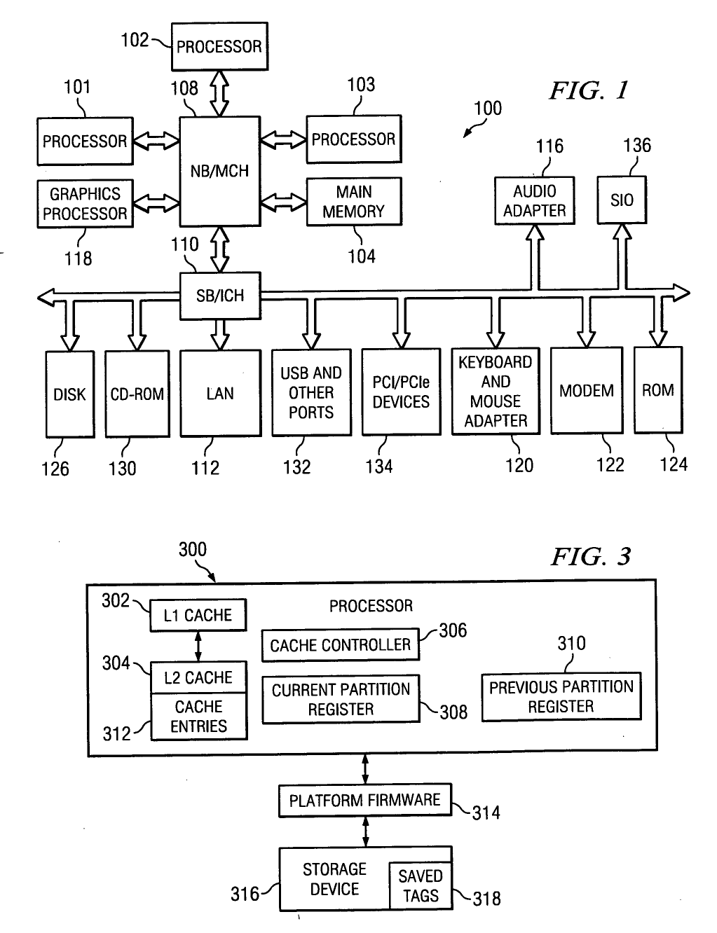

With reference now to the figures, and in particular, to FIG. 1, a block diagram of a data processing system is shown in which aspects of the present invention may be implemented. Data processing system 100 is an example of a computer, such as computer 100 in FIG. 1, in which code or instructions implementing the processes of the present invention may be located. In the depicted example, data processing system 100 employs a hub architecture including a north bridge and memory controller hub (MCH) 108 and a south bridge and input/output (I/O) controller hub (ICH) 110. Processor 101, processor 102, processor 103, main memory 104, and graphics processor 118 are connected to north bridge and memory controller hub 108. Graphics processor 118 may be connected to the north bridge and memory controller hub 108 through an accelerated graphics port (AGP), for example.

In the depicted example, local area network (LAN) adapter 112, audio adapter 116, keyboard and mouse adapter 120, modem 122, read only memory (ROM) 124, hard disk drive (HDD) 126, CD-ROM drive 130, universal serial bus (USB) ports and other communications ports 132, and PCI/PCIe devices 134 connect to ICH 110. PCI/PCIe devices may include, for example, Ethernet adapters, add-in cards, PC cards for notebook computers, etc. PCI uses a card bus controller, while PCIe does not. ROM 124 may be, for example, a flash binary input/output system (BIOS). Hard disk drive 126 and CD-ROM drive 130 may use, for example, an integrated drive electronics (IDE) or serial advanced technology attachment (SATA) interface. A super I/O (SIO) device 136 may be connected to ICH 110.

An operating system runs on processor 101, processor 102, and processor 103, and coordinates and provides control of various components within data processing system 100 in FIG. 1. The operating system may be a commercially available operating system such as Microsoft® Windows® XP (Microsoft and Windows are trademarks of Microsoft Corporation in the United States, other countries, or both). An object oriented programming system, such as the Java programming system, may run in conjunction with the operating system and provides calls to the operating system from Java programs or applications executing on data processing system 100 (Java is a trademark of Sun Microsystems, Inc. in the United States, other countries, or both).

Instructions for the operating system, the object-oriented programming system, and applications or programs are located on storage devices, such as hard disk drive 126, and may be loaded into main memory 104 for execution by processor 101, processor 102, and processor 103. The processes of the present invention are performed by processor 101, processor 102, and processor 103 using computer implemented instructions, which may be located in a memory such as, for example, main memory 104, read only memory 124, or in one or more peripheral devices.

Those of ordinary skill in the art will appreciate that the hardware in FIG. 1 may vary depending on the implementation. Other internal hardware or peripheral devices, such as flash memory, equivalent non-volatile memory, or optical disk drives and the like, may be used in addition to or in place of the hardware depicted in FIG. 1. Also, the processes of the present invention may be applied to a multiprocessor data processing system.

In some illustrative examples, data processing system 100 may be a personal digital assistant (PDA), which is configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 104 or a cache such as found in MCH 108. A processing unit may include one or more processors or CPUs. The depicted examples in FIG. 1 and above-described examples are not meant to imply architectural limitations. For example, data processing system 100 also may be a tablet computer, laptop computer, or telephone device in addition to taking the form of a PDA.

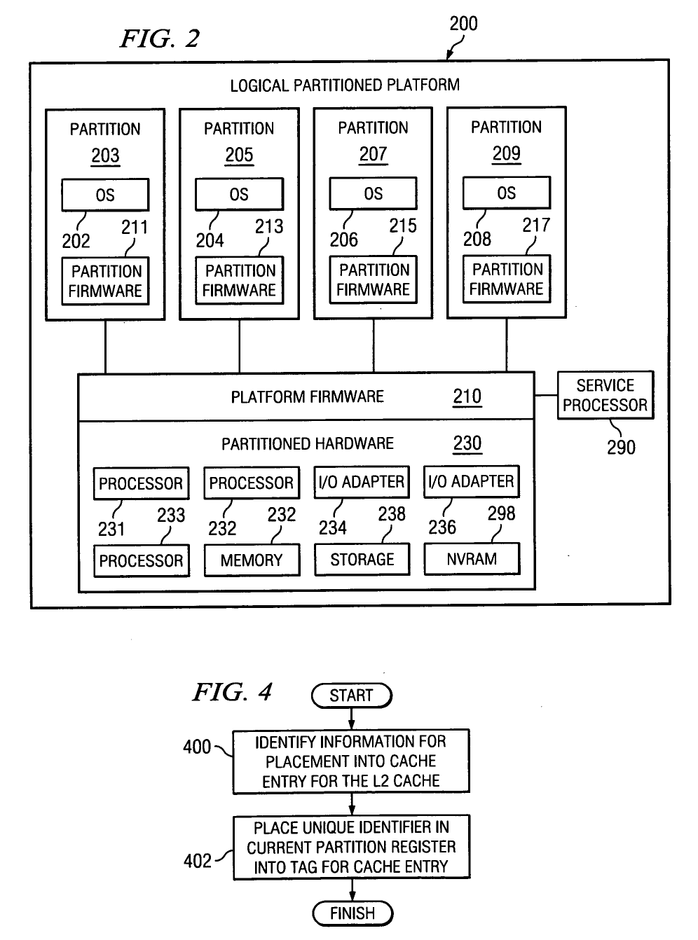

With reference now to FIG. 2, a block diagram of an exemplary logical partitioned platform is depicted in which the present invention may be implemented. The hardware in logical partitioned platform 200 may be implemented as, for example, data processing system 100 in FIG. 1. Logical partitioned platform 200 includes partitioned hardware 230, operating systems 202, 204, 206, 208, and partition management firmware 210. Operating systems 202, 204, 206, and 208 may be multiple copies of a single operating system or multiple heterogeneous operating systems simultaneously run on logical partitioned platform 200. These operating systems may be implemented using Advanced Interactive Executive (AIX®), which are designed to interface with a partition management firmware, such as Hypervisor. AIX® and Hypervisor are products of International Business Machines Corporation. AIX® is used only as an example in these illustrative embodiments. Of course, other types of operating systems, such as linux, may be used depending on the particular implementation. Operating systems 202, 204, 206, and 208 are located in partitions 203, 205, 207, and 209. Hypervisor software is an example of software that may be used to implement partition management firmware 210. Firmware is “software” stored in a memory chip that holds its content without electrical power, such as, for example, read-only memory (ROM), programmable ROM (PROM), erasable programmable ROM (EPROM), electrically erasable programmable ROM (EEPROM), and nonvolatile random access memory (nonvolatile RAM).

Additionally, these partitions also include partition firmware 211, 213, 215, and 217. Partition firmware 211, 213, 215, and 217 may be implemented using initial boot strap code, IEEE-1275 Standard Open Firmware and runtime abstraction software (RTAS), which is available from International Business Machines Corporation. When partitions 203, 205, 207, and 209 are instantiated, a copy of boot strap code is loaded onto partitions 203, 205, 207, and 209 by partition management firmware 210. Thereafter, control is transferred to the boot strap code with the boot strap code then loading the open firmware and RTAS. The processors associated or assigned to the partitions are then dispatched to the partition's memory to execute the partition firmware.

Partitioned hardware 230 includes processor 231, processor 232, processor 234, a system memory unit 232, a plurality of input/output (I/O) adapters 234 and 236, and a storage unit 238. These components are shared by the partitions within logical partitioned platform 200, each of which corresponds to one of operating systems 202, 204, 206, and 208.

Partition management firmware 210 performs a number of functions and services for partitions 203, 205, 207, and 209 to create and enforce the partitioning of logical partitioned platform 200. Partition management firmware 210 is a firmware implemented virtual machine identical to the underlying hardware. Thus, partition management firmware 210 allows the simultaneous execution of independent operating system (OS) images 202, 204, 206, and 208 by virtualizing all the hardware resources of logical partitioned platform 200.

The different aspects of the present invention provide a method, apparatus, and computer usable code for pre-establishing a cache footprint for shared processor logical partitions. The aspects of the present invention allow platform firmware or other components to prefetch much of the cache footprint for the incoming partition in a manner that allows the data to be waiting in and near the L2 cache. To prefetch information in these examples, means bringing data or instructions into a higher-speed storage or memory before the information is actually processed. These aspects of the present invention allow the content of the L2 cache to be close to the configuration that was present the last time the partition was running.

In this manner, the incoming partition may make useful progress quickly in execution because much of the information that the partition needs is immediately available in the cache. Information in the caches in these examples includes instructions, data to be operated on by instructions, or a combination of the two. By prefetching data that was previously present in the L2 cache the last time the partition was running, time is saved by avoiding the time consuming process by bringing information into the L2 cache as the information is accessed from main memory when the information is needed.

The different aspects of the present invention involves changing processor hardware. Two special purpose registers are added to a processor for use in implementing these different aspects of the present invention. One register contains a unique identifier for the currently executing partition and the virtual processor. The other register contains a unique identifier for the partition that previously ran as well as the virtual processor identifier.

Shared processor logical partitions can contain multiple virtual processors, therefore the virtual processor is identified within the partition in order to prefetch the correct data on the correct virtual processor. With a single processor system having shared processor logical partitions, a virtual processor identifier is unnessesary because all of the partitions are mapped to the same physical processor. In contrast, with multiple processors, different partitions may be assigned to a virtual processor that may use one or more different physical processors. As a result, the virtual processor identifier is employed. The illustrative examples are described with respect to a multiprocessor system employing virtual processor identifiers.

Turning now to FIG. 3, a diagram illustrating components used in managing cache entries in a multi-level cache system is depicted in accordance with an illustrative embodiment of the present invention. In these examples, processor 300 contains L1 cache 302 and L2 cache 304. The management of information in these caches is performed using cache controller 306.

Current partition register 308 in processor 300 is an added register containing a current partition identification of the partition that is currently being run by processor 300. Current partition register 308 also contains an identification of the virtual processor assigned to the partition. Previous partition register 310 also is an additional register used in these examples and contains a previous partition identification and identification of the virtual processor assigned to the partition. This register identifies the previous partition that was run by processor 300. Cache entries 312 contain information that may be used by processor 300 during execution of a partition. In these examples, each cache entry is a cache line or block of information. A cache line is an amount of data transferred between main memory and a cache through a cache line fill or write back operation performed by cache controller 306. Each cache entry within cache entries 312 is associated with a partition identifier. This partition identifier identifies that last partition that accessed the cache entry.

When a currently running partition is swapped out to run a new or incoming partition, processor 300 sets current partition register 308 with the identification of the new partition. The identification of the partition being swapped out is placed into previous partition register 310. In these examples, the identification of the partitions is through the use of unique identifiers. These unique identifiers contain the identification of the partition and the identification of the virtual processor assigned to the partition. These operations are performed by cache controller 306 in these examples.

Each cache entry is typically associated with a tag. A tag identifies the contents of the cache entry. The aspects of the present invention expands the tag to include space to contain the unique identifier for a partition and the virtual processor that brought the particular cache entry into L2 cache 304. In these examples, the unique identifier contains both the partition identifier and the virtual processor identifier. Depending on the particular implementation, the unique identifier may include only the partition identifier. One example of an implementation that would use a partition identifier without the virtual processor identifier to form the unique identifier is the use of a single processor system that runs multiple instances of operating systems in which different partitions will be switched in and out. Of course the partition identifier may be associated in other ways depending on the implementation.

When information is brought into a full cache, old information is removed or cast out to make room for the new information. In these examples, cache controller 306 selects which information is cast out using different policies. This information may be, for example, instructions or data operated upon by instructions or some combination thereof. For example, a least recently used process may be used to identify cache entries for removal. When a particular cache entry in cache entry 312 is selected for removal, cache controller 306 compares the partition identifier for the selected cache entry with the unique identifier in previous partition register 310. If a match is present between these identifiers, the tag is given to platform firmware 314 for storage in storage device 316. Storage device 316 contains saved tags 318. A typical tag contains, for example, the physical address of the storage (cache) block and state bits that indicate whether the cache block is, for example, modified or shared. In the illustrative examples of the present invention, physical address and the unique identifier are saved in a tag associated with the information. The unique identifier is the identifier of the partition and the virtual processor in these examples. The unique identifier in other cases comprise the identification of the partition. These two identifiers are used when multiple virtual processors are present. The new incoming information has its tag modified to include the unique identifier of the current partition being executed by processor 300. The unique identification for the current partition is retrieved from current partition register 308.

When a partition switch occurs, platform firmware 314 moves the unique identifier of the outgoing partition into previous partition register 310 and places the unique identifier of the new or incoming partition into current partition register 308. At this point in these illustrative examples, platform firmware 314 recalls tags from saved tags 318 stored in storage device 316 that pertain or are associated with the incoming partition. In these illustrative examples, the tags are saved in a list associated with a partition and a virtual processor. A prefetch of this information is then made by retrieving the list for the incoming partition. This list is identified using the unique identifier for the incoming partition and the virtual processor identifier. By the time the incoming partition begins running, most or all of the information that made up the previous cache footprint are again present within cache entries 312, and L2 cache 304.

As a result, the ability to begin processing quickly is greatly expedited. By prefetching the information making up the previous cache footprint, the time needed to access this information is reduced when the partition executes instructions requiring this information. As mentioned before the previous cache footprint is the information that was present when the previous partition was running.

Turning to FIG. 4, a flowchart of a process for marking cache entries is depicted in accordance with an illustrative embodiment of the present invention. The process in FIG. 4 may be implemented in a cache controller, such as cache controller 306 in FIG. 3.

The process begins by identifying information for placement into cache entry for the L2 cache (step 400). The unique identifier in the current partition is placed into the tag for cache entry (step 402), thus ending the process. The unique identifier is obtained from a current partition register, such as current partition register 308 in FIG. 3.

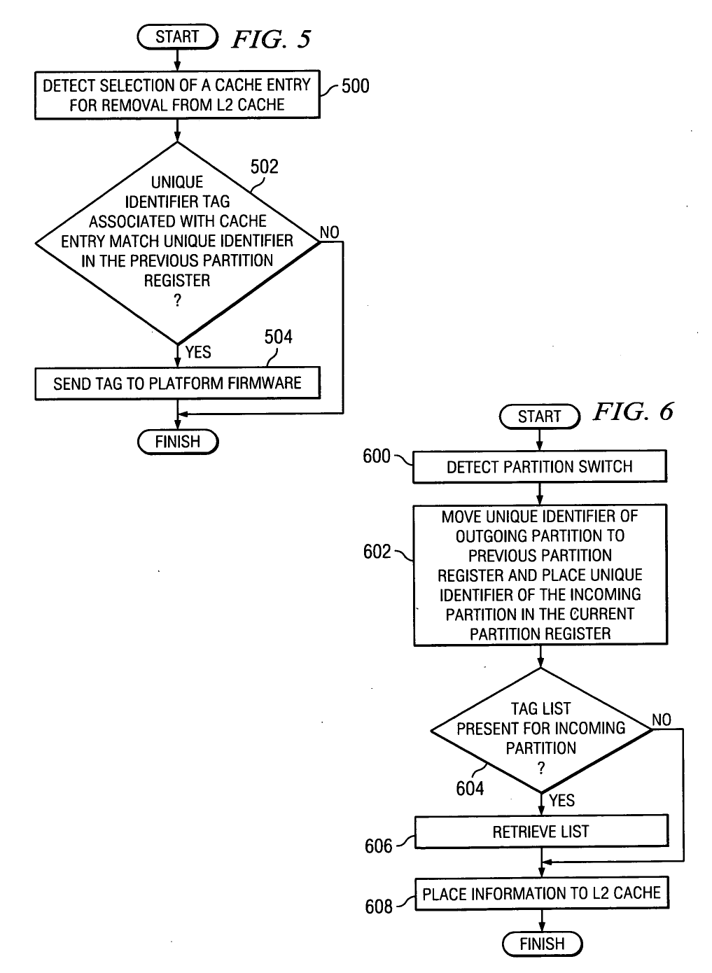

Turning now to FIG. 5, a flowchart of a process for removing cache entries from a cache is depicted in accordance with an illustrative embodiment of the present invention. The process in FIG. 5 may be implemented in a cache controller such as cache controller 306 in FIG. 3. This process is initiated when a cache entry is selected for removal from a cache.

The process begins by detecting a selection of a cache entry for removal for the L2 cache (step 500). A determination is made as to whether the unique identifier tag associated with the cache entry match the unique identifier in the previous partition register (step 502). If a match is not present, the process terminates. If a match is present, the tag is sent to platform firmware for storage in a list (step 504), with the process terminating thereafter. The platform firmware saves these tags to create a footprint to identify the contents of the cache for a previously executing partition based on the unique identifier. Each list is associated with a partition. Thus, when a partition is switched back in for execution by the processor, the tags in the list associated with the partition are retrieved to restore the footprint. This footprint may be used to prefetch information and restore the previous configuration or footprint of the cache when the previous partition is swapped in for execution.

Turning to FIG. 6, a flowchart of a process for prefetching data is depicted in accordance with an illustrative embodiment of the present invention. The process in FIG. 6 may be implemented in a platform firmware, such as platform firmware 314 in FIG. 3.

The process begins by detecting a partition switch (step 600). The platform firmware controls the partition switch in these examples. The unique identifier of outgoing partitions is moved to a previous partition register and the unique identifier of the incoming partition is placed into the current partition register (step 602). Step 602 is performed by the platform firmware sending a signal or command to the processor.

A determination is made as to whether a list is present for the incoming partition (step 604). In this determination, the list is searched using the unique identifier of the incoming partition. If a list is present, the list for the incoming partition is retrieved (step 606). Thereafter, the information corresponding to tags in the list is placed into the L2 cache (step 608), with the process terminating thereafter. Turning back to step 604, if a list is not present, the process terminates.

Thus, the different aspects of the present invention provide an ability to pre-establish cache footprints for shared processor logical partitions. The different aspects of the present invention associate unique identifiers for partitions with cache entries. These identifiers are placed into existing tags used to describe these entries. When data is removed from a cache, tags for entries having unique identifiers matching those of a previous partition are stored. At a later time when a partition switch occurs, stored tags with unique identifiers matching an incoming or new partition that is to be executed by the processor are identified.

Those tags are used to prefetch data for placement into the L2 cache to restore the previous footprint for that partition. In these examples, the tags for a particular partition are stored in a list such that the list is used to identify the data to be retrieved.

The invention can take the form of an entirely hardware embodiment, an entirely software embodiment or an embodiment containing both hardware and software elements. In a preferred embodiment, the invention is implemented in hardware, which includes hardware registers and a special cache controller in the form of on-chip hardware in which the processes of the present invention are implemented.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. For example, the illustrative embodiments are directed towards an L2 cache. The mechanism of the present invention may be applied to other types of caches other than an L2 cache. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for managing cache information in a logical partitioned data processing system, the computer implemented method comprising:
determining whether a unique identifier in a tag associated with a cache entry in a cache matches a previous unique identifier for a currently executing partition in the logical partitioned data processing system when the cache entry is selected for removal from the cache; and
saving the tag in a storage device if the unique identifier in the tag matches the previous partition identifier.

2. The computer implemented method of claim 1 further comprising:
detecting a partition switch to an incoming partition, wherein the incoming partition has an incoming unique identifier;
identifying tags in the storage device having unique identifiers for the incoming partition to form a set of identified tags; and
placing information into the cache using the set of identified tags.

3. The computer implemented method of claim 1 further comprising:
associating a new tag with a new cache entry when the new cache entry is created, wherein the new tag also comprises an identification of content in the new cache entry; and
placing a current unique identifier for the currently executing partition in the new tag.

4. The computer implemented method of claim of claim 1 further comprising:
copying the current partition identifier from a current partition register in a processor of the logical partitioned data processing system in to a previous partition register in the processor of the logical partitioned data processing system when a partition switch occurs, wherein the current partition register stores a first identification of the currently executing partition and the pervious partition register stores a second identification of a previously executing partition.

5. The computer implemented method of claim 1, wherein the cache is a level 2 cache and wherein a set of tags are stored in the storage device for a previously executing partition, wherein the set of tags identifies a data in the level 2 cache used by the previously executing partition, and the set of tags are used to re-establish the data used by the previously executing partition in the level 2 cache when the previously executing partition is switched in for execution.

6. The computer implemented method of claim 1, wherein the saving step comprises a cache controller sending cache entry to a platform firmware if the tag matches the previous partition identifier, wherein the platform firmware stores the cache entry in the storage device.

7. The computer implemented method of claim 2, wherein the placing step returns at least a portion of the cache to a previous footprint present when the incoming partition was previously being executed.

8. The computer implemented method of claim 1, wherein the logical partitioned data processing system is a shared processor logical partitioned data processing system.

9. A computer program product comprising:
a computer usable medium including computer usable program code for managing cache information in a logical partitioned data processing system, said computer program product comprises:
computer usable program code for determining whether a unique identifier in a tag associated with a cache entry in a cache matches a previous unique identifier for a currently executing partition in the logical partitioned data processing system when the cache entry is selected for removal from the cache; and
computer usable program code for saving the tag in a storage device if the unique identifier in the tag matches the previous unique identifier.

10. The computer program product of claim 9, wherein the computer usable program code further comprises:
computer usable program code for detecting a partition switch to an incoming partition, wherein the incoming partition has an incoming unique identifier;
computer usable program code for identifying tags in the storage device having unique identifiers for the incoming partition to form a set of identified tags; and
computer usable program code for placing information into the cache using the set of identified tags.

11. The computer program product of claim 9, wherein the computer usable program code further comprises:
computer usable program code for associating a new tag with a new cache entry when the new cache entry is created, wherein the new tag also comprises an identification of content in the new cache entry; and
placing a current unique identifier for the currently executing partition in the new tag.

12. The computer program product of claim of claim 9, wherein the computer usable program code further comprises:
computer usable program code for copying the current unique identifier from a current partition register in a processor of the logical partitioned data processing system in to a previous partition register in the processor of the logical partitioned data processing system when a partition switch occurs, wherein the current partition register stores a first identification of the currently executing partition and the pervious partition register stores a second identification of a previously executing partition.

13. The computer program product of claim 9, wherein the cache is a level 2 cache and wherein a set of tags are stored in the storage device for a previously executing partition, wherein the set of tags identifies a data in the level 2 cache used by the previously executing partition, and the set of tags are used to re-establish the data used by the previously executing partition in the level 2 cache when the previously executing partition is switched in for execution.

14. The computer program product of claim 9, wherein the computer usable program code for saving the tag in a storage device if the unique identifier in the tag matches the previous unique identifier comprises a cache controller sending cache entry to a platform firmware if the tag matches the current unique identifier, wherein the platform firmware stores the cache entry in the storage device.

15. The computer program product of claim 10, wherein the computer usable program code for placing information into the cache using the set of identified tags returns at least a portion of the cache to a previous footprint present when the incoming partition was previously being executed.

16. The computer program product of claim 9, wherein the logical partitioned data processing system is a shared processor logical partitioned data processing system.

17. A data processing system comprising:
a bus;
a communications unit connected to the bus;
a storage device connected to the bus, wherein the storage device includes a computer usable program code; and
a processor unit connected to the bus, wherein the processor unit executes the computer usable program code to determine whether a unique identifier in a tag associated with a cache entry in a cache matches a previous unique identifier for a previously executed partition in the logical partitioned data processing system when the cache entry is selected for removal from the cache; and save the tag in a storage device if the unique identifier in the tag matches the previous unique identifier.

18. The data processing system of claim 17, wherein the processor unit further executes the computer usable program code to detect a partition switch to an incoming partition, wherein the incoming partition has an incoming unique identifier; identify tags in the storage device having unique identifiers for the incoming partition to form a set of identified tags; and place information into the cache using the set of identified tags.

19. The data processing system of claim 17, wherein the processor unit further executes the computer usable program code to associate a new tag with a new cache entry when the new cache entry is created, wherein the new tag also comprises an identification of content in the cache entry; and place a current unique identifier for the currently executing partition in the new tag.

20. The data processing system of claim of claim 17, wherein the processor unit further executes the computer usable program code to copy the current unique identifier from a current partition register in a processor of the logical partitioned data processing system in to a previous partition register in the processor of the logical partitioned data processing system when a partition switch occurs, wherein the current partition register stores a first identification of the currently executing partition and the pervious partition register stores a second identification of a previously executing partition.
